(19) United States
(12) Patent Application Publication
(10) Pub. No.: US 2007/0136180 A1
(43) Pub. Date: Jun. 14, 2007

(54) System and methods for creating, trading, and settling currency futures contracts

(76) Inventors: David Salomon, Beverly Hills, CA (US); Vincent Viola, Chatham, NJ (US); Larry Harris, Los Angeles, CA (US)

Correspondence Address: CLIFFORD CHANCE US LLP, 31 WEST 52ND STREET, NEW YORK, NY, 10019-6131, US

(21) Appl. No.: 11/389,397

(22) Filed: Mar. 24, 2006

Related U.S. Application Data
(63) Continuation-in-part of application No. 11/304,059, filed on Dec. 14, 2005, now abandoned.

(51) Int. Cl. G06Q 40/00

(52) U.S. Cl. 705/37; 705/36 R

(57) ABSTRACT

The present invention provides for an electronic exchange that provides a marketplace for the trading and settling of currency futures contracts, having methods and systems that include features such as an enhanced execution facility, clearing facility and futures contracts to facilitate such market without the disadvantages of the existing foreign exchange market centers and currency futures contract markets.

### CROSS REFERENCE TO RELATED APPLICATIONS

This application is a continuation-in-part of U.S. patent application Ser. No. 11/304,059, filed on Dec. 14, 2005, and entitled “System and Methods for Clearing, Trading, Settling, and Clearing Currency Futures Contracts.”

### FIELD OF THE INVENTION

The present invention relates generally to currency trading and, more particularly, to creating, trading, and settling currency futures contracts.

### BACKGROUND AND EXISTING MARKETS

As access to financial information has become increasingly ubiquitous, trading currencies has become an industry unto itself. Not only are major institutions (e.g., banks and major corporations) every day trading billions of dollars worth of currency and contracts for currency, small firms and even individuals have become active traders. As a result, non-centralized, unregulated currency markets, such as a foreign exchange market center for “spot” delivery and payment and forward sales for deferred final settlement (see FIG. 1), and centralized, regulated markets, such as for currency futures contracts have become major centers of currency trading (see FIG. 2). A currency futures contract is an agreement to buy or sell a fixed quantity and type of a particular currency for delivery at a predetermined date in the future at a set price. A market for currency futures contracts would normally be comprised of a series of periodic currency futures contracts.

Referring first to non-centralized markets, “spot” transactions for sales of agreed amounts of currency can be entered into on any business day and normally are performed by deliveries of currencies (“final settlement”) on the second business day thereafter (herein, such date of final settlement being referred to as the “value date” or “final settlement date” for a transaction). Non-centralized markets also offer transactions with a value date beyond spot transactions' standard second business day value date. These “forward” transactions for sales of agreed amounts of currency can be entered into on any business day and normally are finally settled on a value date one or more months thereafter, although forward contracts can have shorter or longer duration from transaction to value date. In addition, for completeness, non-deliverable forward contracts, swap contracts and option contracts (collectively, “derivatives”) for varying amounts of currency and varying duration also are traded in the non-centralized markets.

Referring next to centralized markets, such as for currency futures contracts, such markets offer contracts, each of which is for the purchase and sale of a standardized fixed amount of a particular currency and which can be entered into on any business day. Each such currency futures contract has a predetermined value date that is one of a limited number of standardized periodic value dates for that currency and amount. Typically such markets offer, for particular amounts of a particular currency, separate contracts with only four (4) value dates during the year (on which the contract must be finally settled), although for some currencies separate contracts with twelve (12) monthly value dates or different amounts are offered.

For each type of currency or futures contract transaction (spot, forward, futures and other contracts for delivery of currency collectively referred to herein as “currency contracts”), on the applicable value date each party to the transaction is required to fulfill its obligations under the contract either by way of delivery of the particular amount of the currency sold, or acceptance of the particular amount of the currency purchased and satisfaction of the corresponding payment obligation. For a variety of economic and practical reasons, when a market participant trades in a particular currency contract, the market participant may or may not intend to finally settle that contract on the value date, and thus in some instances may instead purchase or sell such a contract before the value date arrives. Moreover, as will be addressed below, as the value date for a currency contract approaches, a party with a contractual obligation to finally settle may prefer instead to defer its final settlement obligation, or to achieve the economic equivalent to such a deferral.

The non-centralized markets for spot transactions are typically the most active and liquid, and as such, spot transactions typically establish pricing benchmarks for purchase and sale of particular amounts of a currency. With forward transactions and futures contracts, on the other hand, prices for sales of particular amounts of a currency typically differ from those for like spot transactions. Such pricing differences principally are due to the longer duration from transaction to value date and differences in the relative interest rate level for each relevant currency's jurisdiction.

As to existing non-centralized markets, referring to FIG. 1, a foreign exchange market center 100 is a restricted network through which currencies presently are traded. For example, the foreign exchange market center 100 allows both spot transactions and forward transactions to be made for the purchase and sale, for spot (second business day) or later final settlement, respectively, of Swiss Francs, Japanese Yen, European Euros, United States Dollars and other currencies. The foreign exchange market center 100 comprises a group of members 120, 130, 140 and 150, communicating with one another via a communications network 110. Although FIG. 1 depicts only four members 120, 130, 140 and 150, foreign exchange market center 100 facilitates communication by and among any number of members over communications network 110.

As a matter of practice, significant credit and systems related issues limit membership, and thereby direct participation, in the foreign exchange center 100 almost exclusively to accredited Banks and other financial institutions. Non-members of the foreign exchange market center 100, however, including by way of non-limiting example individuals, firms, corporations and others (each a “customer” and collectively, “customers”), are able to trade on an indirect basis via the foreign exchange market center 100. For a customer to trade and access the foreign exchange market center 100, the customer must establish a relationship with a bank member of the foreign exchange market center 100, permitting the customer to engage in trading wherein the customer's bank member acts either for the banks' proprietary account or as a “prime broker” for the customer's account(s).

For example, in FIG. 1, in a simplified exemplary arrangement, customer 160, a non-member of the foreign exchange center 100, can enter into a transaction with bank member 120 for the purchase of a particular amount of a currency. In the exemplary arrangement, customer 160 buys the particular amount of the currency from bank member 120, while bank member 120 enters into the sale transaction for its own proprietary account, later to be finally settled (on the value date) by bank member's 120 delivering, from its own inventory of currencies, the sold amount of currency to customer 160. In an alternative exemplary arrangement, after bank member 120 enters into the transaction with customer 160 and prior to the value date, bank member 120 alternatively could obtain the foreign currency it sold and must deliver by purchasing that currency from a third party via the foreign exchange market center 100. In either of these arrangements, the customer 160 has entered into a transaction on a direct, bilateral basis with bank member 120, with each party to the transaction acting on a principal-to-principal basis, and bank member 120 has been free to negotiate for the best price it can extract from customer 160.

In another example, customers 160 and 170 are non-members of the foreign exchange market center 100. As depicted in FIG. 1, for traders 160 and 170 to trade via the foreign exchange market center 100, each must enter into an agreement to allow bank member 120 to act as its prime broker, thus becoming a customer of the bank member 120 in its prime broker capacity. As prime broker to each customer 160 and 170, bank member 120 receives orders and instructions from each customer 160 and 170. Bank member 120 then carries out the orders and instructions and may charge each customer 160 and 170 prime brokerage fees, which may be in the form of a markup or markdown to the price of currency purchased or sold in each transaction. By way of further example, bank member 120 may charge customer 160 a prime brokerage fee for purchasing currency on the foreign exchange market center 100. Bank member 120 may additionally charge customer 160 a separate prime brokerage fee if trader 160 orders the sale of the spot currency contract (which sale customer 160 may prefer instead of accepting delivery of the purchased currency on the value date). When acting as prime broker, bank member 120 acts as a principal in respect of each transaction and thus acts in respect of each customer 160 and 170 as seller whenever that customer 160 or 170 is buyer, and vice versa. Consequently, on the value date, each customer 160 and 170 finally settles its transaction directly with its prime broker, in this example bank member 120.

In a further illustrative example, customer 160 may utilize its prime broker arrangement with bank member 120 to trade with another bank member 130. As depicted in FIG. 1, customer 160 may arrange a trade with another bank member 130 and then provide bank member 130 the name of customer's 160 prime broker bank member 120 for purposes of booking and settling the trade such that the trade will be booked as having been directly between bank member 130 and the prime broker bank member 120. Concurrently, prime broker bank member 120 will book a “mirror image” trade between prime broker bank member 120 and customer 160. As prime broker to customer 160, bank member 120 acts as principal on each of these trades and will finally settle each trade separately, subject to credit risk. For this service, which has afforded foreign exchange market center 100 non-member, customer 160, the effective opportunity to trade with a foreign exchange market center 100 member, bank member 130, bank member 120 charges customer 160 a prime brokerage fee, which may be in the form of, by way of non-limiting example, a markup or markdown to the price of currency purchased or sold in the transaction.

If a customer 160 desires to defer final settlement obligations under a currency contract beyond the contract's value date, for example to maintain open exposure to currency price fluctuations rather than finally settle the trade on its value date, customer 160 may arrange with its prime broker bank member 120 to “roll the trade forward,” whereby bank member 120 extinguishes the initial trade and enters into a new trade with customer 160 for the same amount of currency but with a new, more distant value date. Due to the contractual obligations of the initial transaction, the market structure and the central role of bank member 120 as prime broker for and principal to the initial transaction, if customer 160 seeks to “roll the trade forward” it can do so with bank member 120, and only upon terms acceptable to its prime broker bank member 120 and without any benefit of direct price competition. This roll forward transaction may be agreed in advance by customer 160 and its prime broker bank member 120 to occur automatically, absent contrary instruction from customer 160, at a “reasonable” rate as determined by the prime broker, which rate need not be the most favorable rate available in the market.

For example, in the foreign exchange market center depicted in FIG. 1, if customer 160, utilizing the services of bank member 120 as its prime broker, enters into a trade with bank member 130, customer 160 will be required to negotiate any roll forward of such trade with its prime broker bank member 120, rather than being free to seek a competitive price from any other bank member, for example bank member 130, because there is no central clearing facility and because, by utilizing the prime brokerage system, customer 160 has limited its direct trading relationship to bank member 120. Although, in principle, customer 160 could negotiate a roll forward with another bank member, such as bank member 140, and then provide bank member 140 the name of customer's 160 prime broker bank member 120 for purposes of booking and settling the trade, in practice customer 160 cannot effect such a transactions because the trade that extinguishes the initial trade would require one-day final settlement between bank member 140 and bank member 130, which can only be arranged for a premium price to customer 160.

The foreign exchange market center 100 is not a centralized market where prices are made and published. Furthermore, whereas customers are not typically direct participants in foreign exchange market centers nor participants in all relevant centers, prime broker bank member 120 may be a member of all relevant centers. Consequently, whereas prices for currency on all relevant markets may not be transparent to all customers 160 and 170 at all times, such prices typically are transparent for bank member 120. Customers 160 and 170 who trade on the foreign exchange market center 100 thus trade with imperfect information, and therefore are at a disadvantage compared to bank member 120, which has access to essentially all relevant foreign exchange market center 100 information.

Customer 160 also may be disadvantaged by its prime broker bank member's 120 knowledge of its customers' positions, order flows, typical trading patterns and financial wherewithal. As prime broker, bank member 120 typically trades foreign currency for the purpose of making profits in its proprietary accounts, as well as to facilitate trades on behalf of customers. Bank member 120, acting in that dual capacity, has a potential conflict of interest. Having both greater knowledge of market prices as well as knowledge of customer positions, order flow and typical trading patterns, bank member 120 may arrange its affairs to exploit this information to the detriment of customer 160 either by trading ahead of, along side of or against, customer 160. Such bank trading, which could adversely affect the prices available to, and ultimately obtained by, customer 160, is not statutorily or regulatorily restricted in the unregulated foreign currency market center 100. In addition, bank member 120 may have an ownership or other economic interest in the trading platform utilized by the foreign exchange market center 100, or even in the foreign exchange market center 100 itself. Such ownership interest can provide bank member 120 with further competitive information about other market participants and may bias brokerage decisions that bank member 120 makes on behalf of its customers when trading as an agent.

Because customer 160 always must deal with or through a bank member 120 to enter into and finally settle foreign exchange market center 100 transactions, customer 160 is exposed to the creditworthiness of bank member 120. Furthermore, because prime broker arrangements typically are exclusive, customer 160 will be exposed exclusively or primarily to the creditworthiness of a single prime broker, which is an arrangement that may be burdensome and costly to change due to the lengthy processes involved in establishing credit, legal and systems relationships needed to support trading, and especially prime broker, arrangements. Thus, customer 160 may be impelled to undertake or continue an otherwise imprudent level of concentrated credit risk in respect of bank member 120 or its prime broker in order to obtain the access to the foreign currency market center 100 that it desires for trading purposes.

As an example of the drawbacks of the existing systems, customer 160 wishes to buy on Jan. 10, 2006 an amount of a currency for standard two-day spot final settlement, that is, for final settlement on Jan. 12, 2006, and places the appropriate instruction with the bank member 120 to execute the purchase. On the same day, customer 170 also contacts bank member 120 and places an appropriate instruction to sell the same amount of the same currency. Instead of matching the customer 160 and customer 170 at a mid-point between customer's 160 bid purchase price and customer's 170 offered sale price, bank member 120 may execute customer's 160 buy instruction at bank member's 120 offered sale price, and may execute customer's 170 sell instruction at bank member's 120 bid purchase price. As a result, bank member 120 captures the difference between the two prices, the spread, to the disadvantage of each of customers 160 and 170, each of which would have been able to obtain a better price had it been able directly to match the bid and offer.

Customers have limited access and ability to trade currency on the foreign exchange market center. As a result, in addition to trades, customers may be charged prime brokerage fees by bank members for orders or instructions. The fees may be explicit or implicit in the prices customers obtain. Further, as a result of limited access to the foreign exchange market centers, customers receive imperfect price information and trade principally by indirect action. The foreign exchange market center operates inefficiently from the perspective of customers because customers have different access to information at different times and lack direct access to potential transaction counterparties. Such foreign exchange market center inefficiencies also give rise to public policy implications. Many customers are corporate entities that access the currency markets in the ordinary course of international commerce. Price inefficiency in currency markets faced by such customers ultimately will result in increased costs of goods and services in international commerce and lower investment returns achieved by international investors.

Therefore, there is a need for systems and methods for trading, clearing and settling currency transactions without the disadvantages of trading on the foreign exchange market center 100.

Turning now to the centralized markets, referring to FIG. 2, a currency futures contract market 200 includes a central execution facility 210 where contracts for future delivery of currencies (“currency futures contracts”) presently are traded. The currency futures contract market 200 comprises a central execution facility 210 where market members may trade with one another in currency futures contracts, either by manual open outcry auction or through an electronic trading platform.

Individuals, firms, corporations and many other non-members of the currency futures contract market 200 trade within that market every day. In order to do so, the non-member (the “futures customer”) must enter into an agreement with a member 220 of the currency futures contract market that allows that member to act as an agent (broker) for the account of the non-member futures customer. Upon establishment of a currency futures contract through such an execution facility, the contract is novated and each member becomes counterparty to a contract with a central clearing facility (each, a “clearing facility contract”). Upon such novation of a currency futures contract, such central clearing facility becomes the buyer to the seller under the currency futures contract, and becomes the seller to the buyer under the currency futures contract.

For example, futures customers 250 and 260 are not members of the currency futures contract market. As depicted in FIG. 2, in order for customers 250 and 260 to trade on the currency futures contract market 200, each will need to enter a brokerage agreement and open an account with one or more members 220 and 230 or with another broker who, in turn, has a direct or indirect account with one or more members who act as brokers/agents. Thereafter, the instructions of customers 250 and 260 to place orders for contracts will be followed by their respective brokers 220 and 230 and contracts may be entered for the account of the relevant futures customer. At some currency futures contract markets, many such brokers have created systems that automatically forward their customers' orders, thus permitting their customers to effectively directly access the exchange trading systems.

The currency futures contract market 200 is a centralized market where standardized, fungible contracts for future delivery of currencies are listed for trading. Those contracts normally are denominated in large, standardized amounts, with US$100,000 or its foreign currency equivalent, or more, being the norm. At exchanges employing open outcry auctions, prices of contracts are broadly disseminated on the floor to on-site exchange members who, in turn, transmit price information to futures customers. Similarly, a currency futures contract market utilizing an electronic trading platform broadly disseminates prices electronically. Consequently, the prices of currency contracts are transparent to all futures customers at all times. Furthermore, unlike the foreign exchange market centers (see FIG. 1), where spot and deferred final settlement transactions are made, markets for trading in currency futures contracts are regulated under the U.S. federal Commodity Exchange Act, and both the currency futures contract market 200 and its related execution facility 210 and clearing facility 240 must satisfy certain statutory requirements in order to operate. In addition, trading in the currency futures contracts is regulated. Law, regulations of the Commodity Futures Trading Commission (the “Commission”) and Commission-approved exchange regulations prohibit broker fraud, insider trading and price manipulation, and require customer order time-stamping, other recordkeeping, disclosure of large positions and publication of a single daily contract final settlement price.

Access to the currency futures contracts is not restricted to select financial institutions. Public access is available by establishing an agreement with one or more of the exchange members to act as the agent of the customer. Brokerage fees are transparent and agreed upon on a competitive basis, and exchange and clearing fees, which also are transparent, are determined in the context of competition between competing exchanges. Due to the better information available, futures customers have better opportunities to arrange trades on the most favorable terms. From the perspective of foreign exchange customers, the currency futures contract market operates more efficiently as compared to the foreign exchange market center.

The standardization of futures contracts at large monetary amounts of US$100,000 or its foreign currency equivalent, or more, makes futures contracts an imprecise and imperfect instrument for some purposes and therefore uneconomic for some traders. For example, using futures contracts can be an imperfect or uneconomic means to hedge certain currency risks, either because the overall risk while large is not in an increment equal to the futures contract monetary amount or because the currency risk is smaller than the futures contract monetary amount. Futures contracts with large monetary amounts also are unsuitable for customers seeking to speculate on a small scale or to use the contracts as a means to supply currency for personal use.

Among the considerations in pricing of currency transactions for deferred final settlement, including, among others, currency futures contracts, is the relative interest rate level for each relevant currency's jurisdiction, as it affects the cost of financing the currency until the final settlement date. Because a currency futures contract market is a market for leveraged contracts with generally longer duration, often months or years, the relevant interest rate differentials generally cause prices for those contracts to differ materially from prices for shorter term currency transactions on the foreign exchange market center. Moreover, changes in the interest rate differential cause the difference between the prices for spot transactions and for futures contract transactions to vary. Futures contract prices thus are subject to different levels of volatility. This divergence may detract from a futures customer's ability to obtain the economic effects of a spot transaction when trading in a futures contract. Consequently, the open and competitive advantages of futures contracts presently are not available to customers interested in trading futures contracts that closely represent short-term spot currency values.

For example, a United States company with international operations may have a temporary surplus of European Euros, the value of which it wishes to hedge for a matter of days. Use of futures contracts, however, may provide an inadequate hedge. This is because the shortest available futures contract may mature in a matter of weeks or months so that any changes in the interest rate differential will cause changes in the prices of the relatively long-term futures contract to differ from changes in the short-term spot price which is the price relevant to the hedge.

The greatest liquidity normally is found in futures contracts with durations of several months or less (“near futures contracts”). Consequently, most futures customers hold such near futures contracts. A futures customer wishing to preserve its position beyond a near futures contract maturity must seek to extinguish the existing futures contract and, by establishing a new position, roll forward that position into a subsequently maturing futures contract; in doing so, such futures customer becomes subject to risk of illiquidity and resultant high costs associated with establishing the new position.

For example, a futures customer 250 with a futures contract that is subject to final settlement at the end of a particular month may wish to extend its position to a subsequently expiring futures contract and, to do so, will sell its existing position to another futures customer 260. Futures customer 250 thereby is likely to pay the difference between the bid and asked price in that transaction, which difference may be exaggerated by then current illiquidity in respect of the relevant futures contract or market awareness of the need of futures customer 250 to roll its contract forward. A similarly exaggerated bid-asked spread difference may occur in respect of futures customer's 250 entry into a new contract to complete the roll forward.

Alternatively, a futures customer may prefer, upon contract maturity, to finally settle such contract by making or taking a delivery of foreign currency. In that event, such futures customer may be subject to inefficient and potentially material transaction costs. For example, such costs may arise due to obligations of futures customer with respect to multiple currency contract obligations, which while economically offsetting, may require multiple physical deliveries rather than being netted out to a lesser physical or cash final settlement. Such costs also may arise due to obligations of futures customer as between its at least one currency futures contract market transaction and at least one transaction to which futures customer may be a party in the foreign exchange market center, which again each must be physically delivered rather than “netted out.” Therefore, to satisfy futures customer's obligations in respect of those currency futures contract market trades, futures customer may be required to make multiple and offsetting deliveries to the counterparties to futures contracts, as well as to its foreign exchange market center trades that are to be finally settled on the same day.

For example, if two futures customers 250 and 260, each of which participates in both currency futures contract trading, as well as currency trading on one or more foreign currency market centers, are matched for final settlement on a futures contract, both customers are obligated to go through each of the steps required to finally settle in each of those markets, regardless of partially or fully counterbalancing final settlement obligations that each customer may have in respect to a foreign currency market center. Similar inefficiency can occur if the two customers have counterbalancing final settlement obligations in two or more foreign currency market centers.

Therefore, there is a need for systems and methods for trading, clearing and settling contracts on currencies, without the disadvantages of the currency futures contract market.

### SUMMARY OF THE INVENTION

Accordingly, the present invention provides for an electronic exchange that provides a marketplace for the trading and settling of currency futures contracts, having methods and systems that include features such as an enhanced execution facility, clearing facility and futures contracts to facilitate such market without the disadvantages of the existing foreign exchange market centers and currency futures contract markets.

Compared to the current foreign exchange market centers, under the present invention customers of currency transactions will benefit from:
a. trading in a transparent market where customers can see all bid, offer and transaction prices as they occur;
b. trading in a centralized market in which they can access the best available bids and offers and make their bids and offers available for everyone to access;
c. trading in an anonymous market in which customers do not have to identify themselves to banks or each other;
d. trading in a well regulated market that restricts conflicts of interest and substantially deters practices that are generally restricted in regulated investment markets;
e. trading in a contract guaranteed by the financial strength of a clearing facility supported by its combined members rather than by the creditworthiness of any specific single counterparty;
f. trading in contracts for which positions can be offset on a competitive and inexpensive basis with anyone up to the time of final settlement; and
g. trading in contracts with a transparent, competitive and thus inexpensive mechanism for rolling forward transactions.

Compared to the current currency futures contract markets, futures customers will benefit from:
a. a futures contract market in which futures customers can arrange trades for final settlement on any day instead of just four or twelve times a year;
b. a futures contract market that provides a more efficient automated mechanism for rolling contracts forward for periods as short as one day;
c. a futures contract market that can be used by futures customers who choose to regularly roll forward one or more futures contracts to produce prices that very closely replicate spot prices;
d. a futures contract market that continuously produces prices that very closely replicate spot prices for those futures customers who are seeking to hedge spot prices;
e. a futures contract market that allows futures customers to specify counterparties for final settlement with whom such futures customers give greater credit or obtain lower settlement costs than the futures commission merchants who clear their trades;
f. a futures contract market whose clearing facility will allow futures customers to net their positions across all accounts maintained at two or more members of the clearing facility (clearing members); and
g. a futures contract with a small trading unit that effectively allows futures customers to trade futures contracts for any amount of currency.

In particular, this new market and its contracts involve the following features and functions.

The new market will offer contracts in several monetary amounts, including very small, so that participants can better size their contract position to their economic needs.

Additionally, the contracts will have daily expirations which will provide, among other benefits, within the context of a regulated futures market the economic equivalence of a more liquid, unregulated spot currency market.

The contract rules will provide for a mechanism to establish, through unrestricted novation, futures contracts with the clearing facility without utilizing the matching feature of the execution facility, as well as to extinguish, through unrestricted denovation, an existing clearing facility contract without utilizing the execution facility, with the advantage that market participants who can find favorable prices in the private, bilateral market can obtain the clearing facility contracts without the risk of having to pay less favorable prices through the execution facility.

A further aspect of the market will be a means for facilitating the efficient rolling forward of futures contracts.

A final aspect of the market will be rules of the clearing facility which facilitate more alternatives and more economically efficient alternatives to settlement procedures.

### BRIEF DESCRIPTION OF THE DRAWINGS

Further characteristics, features and advantages of the present invention will be apparent upon consideration of the following detailed description of the invention, taken in conjunction with the following drawings, and in which:

FIG. 1 illustrates a prior art network for a foreign exchange market center;

FIG. 2 illustrates a currency futures contract market, on which is shown execution and formation of a futures contract;

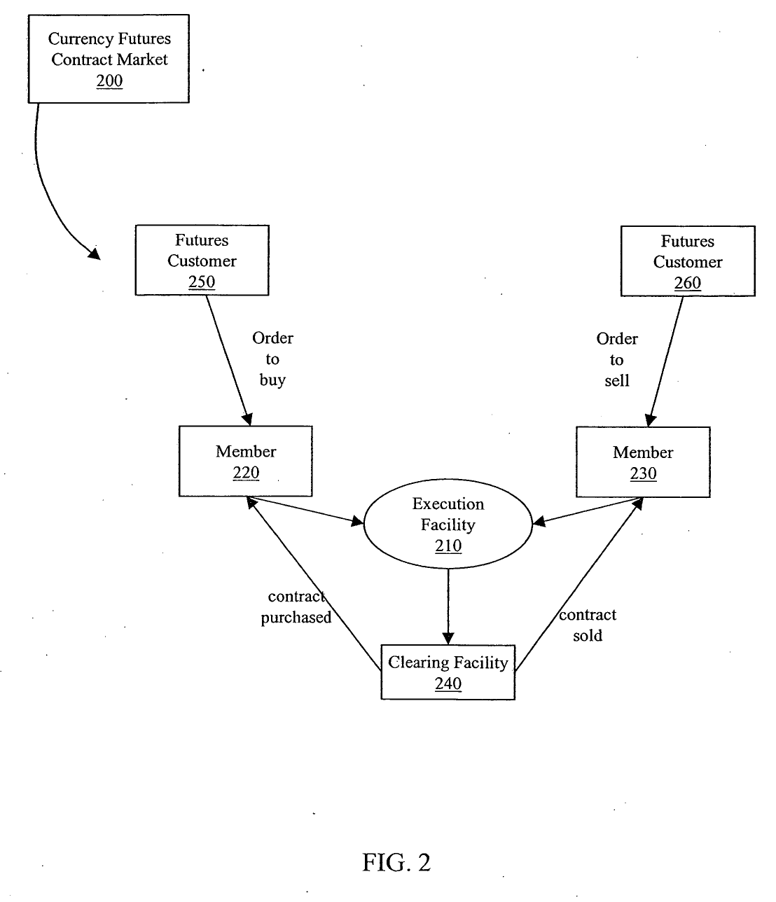

FIG. 3 illustrates a currency futures contract market, on which is shown novation into a futures contract, in accordance with an embodiment of the present invention;

FIG. 4 illustrates a currency futures contract market, on which is shown denovation from a futures contract, in accordance with an embodiment of the present invention;

FIG. 5 illustrates a network for trading a currency futures contract, in accordance with one embodiment;

FIG. 6 is a flowchart depicting an exemplary method for listing a currency futures contract;

FIG. 7 is a flowchart depicting an exemplary method for a trader to roll a currency futures contract position;

FIG. 8 illustrates a block diagram of a digital device that may list the currency futures contract, in accordance with one embodiment; and

FIG. 9 illustrates an exemplary listing of a series of currency futures contracts.

### DETAILED DESCRIPTION OF THE INVENTION

Embodiments of the invention will be described in terms of an electronic exchange market for currency futures contracts.

A currency futures contract can allow traders to take and maintain a position within a currency market while avoiding prime brokerage fees. Fees related to futures trading are competitive with, and generally lower than, prime brokerage fees. A currency futures contract is an agreement to buy or sell a fixed quantity and type of a particular currency for delivery at a predetermined date in the future at a set price.

The currency futures contract may be constructed with terms and conditions to make the currency futures contract economically similar to a trade within a spot currency market. The spot currency market is a market (e.g., a foreign exchange market center) in which currencies are traded for delivery within two business days. Unlike trades on the spot currency market, the currency futures contract can be listed on an exchange (e.g., Chicago Mercantile Exchange or New York Mercantile Exchange) or an electronic trading network. Since the price for each currency futures contract is listed (i.e., publicly available), traders can take advantage of the transparency. Moreover, traders can sell a soon-to-expire currency futures contract in favor of a more distant currency futures contract in order to maintain their position with respect to the underlying currency.

Other terms which are generally defined for purposes of describing various embodiments of the present invention include the following:
calendar spread: a position established by simultaneously obtaining either a long or short in a long-term contract and either a short or long position respectively in a short-term contract, both for the same underlying asset.
denovation: the process of extinguishing or reforming a currency futures contract to form a new forward or spot contract off an exchange.
foreign exchange: the currencies of foreign countries.
foreign exchange market: an international market in which foreign currencies are traded.
novation: the process of reforming or extinguishing a forward or spot contract existing off an exchange in order to form currency futures contracts on an exchange.
order: an instruction to make a transaction at a given or market price.
roll: the substitution of one or more financial instruments for other, typically soon-to-expire instruments to maintain a financial position as instruments expire over time.
final settlement: the exchange of money and/or currencies upon the expiration of a contract.
daily settlement: the daily exchange of payments required to maintain variation margin used by the exchange to secure final settlement as contract prices change.
spot trade: the purchase and/or sale of foreign currency for delivery within two business days.

By trading the currency futures contract, traders can maintain the essential equivalent of spot currency positions without trading on the foreign exchange market center. Since traders do not have to go through a member bank on the foreign exchange to implement trades, traders can save on prime brokerage fees. Further, since information about currency futures contracts is publicly available to all traders, each trader can maximize profit or minimize cost due to the economic efficiencies of price transparency. Moreover, equal access to information can help to ensure that no entity has an unfair advantage.

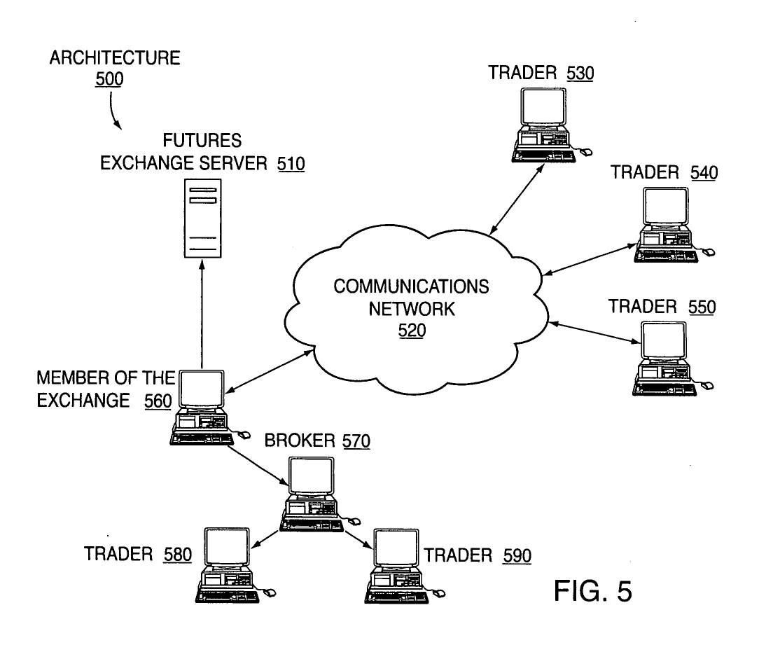

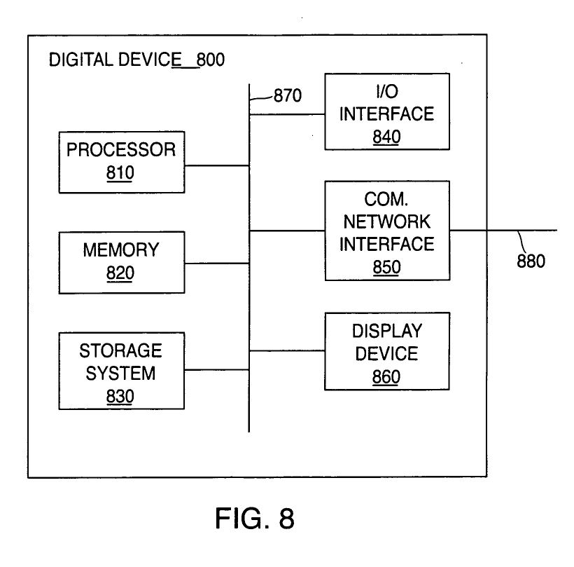

FIG. 5 illustrates an architecture 500 for trading a currency futures contract. In the architecture 500, nodes coupled to a communications network 520 include traders 530, 540, and 550, and a member of the exchange 560. The node is a digital device that communicates with other nodes on the architecture 500. Digital devices are further discussed with reference to FIG. 8. The architecture 500 may be any network coupled to an exchange or electronic trading network where currency futures contracts are traded.

A currency futures contract can comprise an initial listing date, a final settlement date that is after the initial listing date, terms for trading a currency, and a provision to permit a purchaser of the currency futures contract and at least one market participant to novate or denovate the currency futures contract prior to final settlement. The initial listing date is the date that the currency futures contract is first listed on an exchange or electronic trading network. For example, the currency futures contract may be listed as an “SFXF” which is a symbol for “Spot Foreign Exchange Future.” The currency futures contract can be listed as “SFXF” wherein the listing further comprises a date when the currency futures contract will be finally settled. For example, a currency futures contract may be listed as an “SFXF20071201” which would indicate that the currency futures contract will expire on Dec. 1, 2007.

The terms for the currency futures contract comprise a quantity and a type of currency that forms a basis of the currency futures contract. The terms allow the purchaser of the currency futures contract and at least one market participant to novate or denovate the currency futures contract onto or off of an exchange.

The exemplary currency futures contract goes to a final settlement date after the initial listing date. In some embodiments, the final settlement date is two days after the initial listing date. In other embodiments, the final settlement date may be months after the initial listing date. The final settlement date can be any fixed period of time after the initial listing date.

On the final settlement date, the purchaser of the currency futures contract can either deliver or receive the currency identified in the terms. A futures clearing house can perform the delivery. Upon final settlement, the currency futures contract can become a cash transaction.

The exchange or electronic trading network may have one or more centralized servers such as a futures exchange server 510 configured to receive and process trades, orders, or information associated with currency futures contracts. The futures exchange server 510 may also receive and process trades, orders, or information associated with options, futures, derivatives, commodities, stocks, bonds, or any other financial instruments.

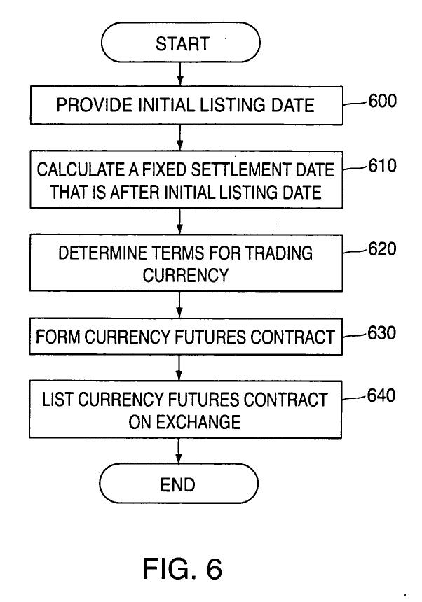

In one embodiment, the futures exchange server 510 is a digital device that is coupled to the exchange or electronic trading network that is configured to receive and process orders or instructions for trading currency and/or futures contracts. A digital device is further discussed with reference to FIG. 6. In some examples, the member of the exchange 560 or a broker 570 operates as the futures exchange server 510.

The futures exchange server 510 may be optionally coupled to the broker 570, or traders 530, 540, 550, 580, or 590. In another example, the futures exchange server 510 may be coupled directly to the communications network 520. The futures exchange server 510 may be coupled to a physical exchange such as the New York Mercantile Exchange or any electronic trading network.

In exemplary embodiments, the member of the exchange 560 is a digital device that is coupled to the futures exchange server 510, the communications network 520, and the broker 570. In one example, only members of the exchange 560 can process orders on the futures exchange server 510. Members of the exchange 560 are nodes operated by individuals or entities that are authorized to send trades, orders, and/or instructions associated with currency futures contracts directly to the futures exchange server 510.

In some embodiments, only the broker 570 can send orders and instructions to the member of the futures exchange 560. The broker 570 can, in turn, receive orders and instructions to trade currency futures contracts with the futures exchange server 510 from clients such as trader 580 and trader 590. In return for this service, the broker 570 can charge the trader 580 and trader 590 brokerage fees. In other examples, the broker 570 is coupled to the communications network 520 and can receive orders and instructions from the traders 530, 540, and 550.

Traders 530, 540, 550, 580, and 590 are nodes configured to transmit trades, orders, and/or instructions associated with currency futures contracts. Any individual or business entity can operate as the traders 530, 540, 550, 580, and 590. Although only five traders are depicted, there may be any number of traders in the network 500.

The communications network 520 couples the nodes together to allow the nodes to communicate and transmit financial data to each other. The communications network 520 may be a single device or multiple devices. In one embodiment, the communications network 520 is a router that routes financial data and information associated with currency futures contracts to a limited number of nodes. In another embodiment, the communications network 520 comprises multiple routers, bridges, and hubs that couple a large number of nodes. The communications network 520 may also be a network, such as the Internet, that allows nodes to communicate and transmit financial data and information associated with currency futures contracts to each other.

Depending upon the topology of the architecture 500, the communications network 520 is optional. For example, the architecture 500 may connect the nodes with a ring topology. In a ring topology, each node communicates directly to one or two other nodes on the architecture 500 without the requirement of the communications network 520. The architecture 500 may also be a peer-to-peer network where nodes receive and transmit financial information and information associated with currency futures contracts with other nodes without the necessity of a dedicated server.

FIG. 6 is a flowchart depicting an exemplary method for listing a currency futures contract. In step 600, an initial listing date is provided. The initial listing date is a date that the currency futures contract is first listed on an exchange or electronic trading network. In one example, the futures exchange server 510 (FIG. 5) may determine the initial listing date of the currency future contract. In another example, a member of the exchange 560 (FIG. 5) may transmit the initial listing date of the currency futures contract to the futures exchange server 510.

In step 610, a final settlement date is calculated that is after the initial listing date. For example, if the listing date of a currency futures contract is December 12, 2005, the final settlement date may be Dec. 14, 2005. In this example, the currency futures contract, similar to a trade on the spot currency market, finally settles two business days forward. In other embodiments, the final settlement date may be any number of days after the initial listing date. The final settlement date may be calculated by the trader 530, the member of the exchange 560, the broker 570, the futures exchange server 510 (FIG. 5), or any node on the exchange or electronic trading network.

In step 620, terms for trading currency are determined. The terms may comprise a quantity and type of currency. For example, the type of the currency is Swiss francs and the quantity is 125,000. The terms for trading currency may be determined by the trader 530, the member of the exchange 560, the broker 570, the futures exchange server 510 (FIG. 5), or any node on the exchange or electronic trading network.

The initial listing date, the calculating of the final settlement date, and the determination of the terms for trading currency can be accomplished in any order.

In step 630, the currency futures contract is formed. In one embodiment, the currency futures contract is based on the initial listing date, the final settlement date, and the terms of the currency futures contract. In some embodiments, the currency futures contract includes an agreement to finally settle the futures currency agreement with at least one trader. The trader may be selected by a purchaser of the currency futures contract, by the exchange through some algorithm, or by the electronic trading network. Once the trader is selected, the purchaser of the currency futures contract may be obligated by the agreement to finally settle the currency futures contract with the selected trader.

The currency futures contract may be finally settled by delivering or receiving the underlying currency identified in the currency futures contract's terms. At final settlement, all currency futures contracts to be finally settled are netted. Remaining obligations of the netted currency futures contract can become a cash transaction that may generally correspond to the cash final settlement of foreign exchange traded in the foreign exchange market center 100.

In step 640, the currency futures contract is listed on an exchange. The currency futures contract may be listed on the exchange after approval by the Commodity Futures Trading Commission (CFTC). In some embodiments, the futures exchange server 510 (FIG. 5) lists the currency futures contract on the exchange. Information relating to the currency futures contracts on the exchange is maintained in a database on the futures exchange server 510.

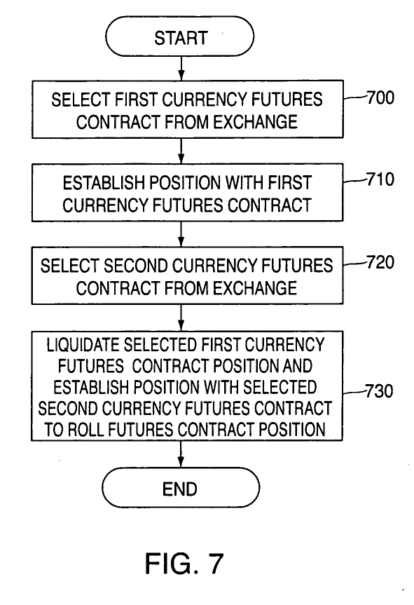

In some embodiments, the exchange can list multiple currency futures contracts. Each of the currency futures contracts can settle on subsequent business days. For instance, a separate currency futures contract may settle on every day of the week. By listing multiple currency futures contracts with final settlement dates set to expire on sequential days, traders can continuously roll their currency positions until a desired day. The process of rolling is further discussed with reference to FIG. 7.

FIG. 7 is a flowchart depicting an exemplary method for a trader to roll a currency futures contract position. A trader can maintain a currency position by selling a first currency futures contract in favor of a second currency futures contract with a later final settlement date. By selling the first currency futures contract with the earlier final settlement date in favor of the second first currency futures contract, the trader can maintain the position and put off final settlement. The trader can continuously trade currency futures contracts in favor of other currency futures contracts with later final settlement dates until the trader decides to finally settle at a desired time.

In step 700, the trader selects a first currency futures contract from an exchange. For example, a trader may select a first currency futures contract for Dec. 12, 2005. The first currency futures contract for Dec. 12, 2005 may be scheduled to finally settle on Dec. 14, 2005. In other embodiments, the trader may select a first currency futures contract from an electronic trading network.

In step 710, the trader buys or sells the selected first futures contract from an exchange. For example, the trader may select the Dec. 12, 2005 contract as the first currency futures contract.

If a currency futures contract is purchased at the exchange, the currency futures contract may further comprise an agreement to allow a clearing house of the exchange to clear settlement and delivery of the currency futures contract. A clearing house of the exchange can be any entity which can clear the currency futures contract.

For example, a trader enters into the selected currency futures contract on Dec. 12, 2005. The selected currency futures contract is to settle on Dec. 14, 2005. The selected currency futures contract is held until the close of business Dec. 13, 2005. At the end of the day on Dec. 12, 2005, the selected currency futures contract may be cleared. The exchange acts as an intermediary in the currency futures contract. When the selected currency futures contract is cleared, the clearing house will net all open positions and demand deposits (margin) to secure any debit balances. In other embodiments, traders agree to allow the clearing of trades in return for the right to trade on the exchange or electronic trading network. In some embodiments, a clearing house is a futures commission merchant.

In step 720, the trader selects a second currency futures contract on a second date from the exchange. The trader can make the selection prior to the settlement of the first currency futures contract. The second currency futures contract may be similar in terms and other respects to the first currency futures contract with the exception of the initial listing date and the final settlement date.

In step 730, the trader sells the first futures contract and buys or sells the second futures contract to roll the futures contract position. For example, the trader can sell the Dec. 12, 2005 currency futures contract prior to final settlement and buy or sell the Dec. 13, 2005 currency futures contract. The new currency futures position may be cleared at the end of the day on Dec. 13, 2005, thereby netting the trader's open positions. The trader may make a gain or loss on the spread between the two currency futures contracts.

By rolling the currency futures contract position, the trader may avoid final settlement of the older currency futures contract (i.e., the currency futures contract bought or sold on Dec. 12, 2005) while taking advantage of the spread. Similarly, the trader may roll the currency futures contract position to net out new currency positions, hedge new trades, or take advantage of other trading opportunities.

Although the embodiment in FIG. 7 depicts a trader rolling a currency futures contract position on an exchange, the trader may roll the currency futures contract position on any electronic trading system. Although multiple platforms may execute the currency futures contract, the currency futures contract typically clears on one exchange or clearing house.

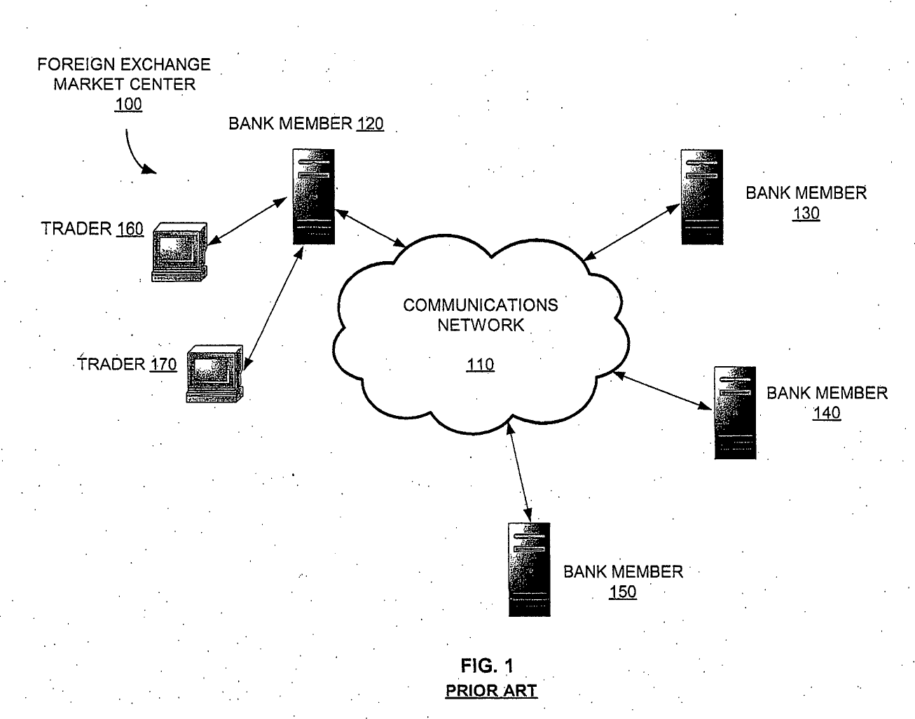

By trading currency futures contracts, a trader can take a position similar to that within the spot currency market without incurring prime brokerage fees on the foreign exchange market center 100 (FIG. 1). Similar to a trade within the spot currency market, the currency futures contract may be settled within two business days. The currency futures contract may be cleared daily, or novated on or off a futures exchange or electronic trading network. Moreover, by rolling currency futures contract positions, a trader can seek to take advantage of the price transparency in order to optimize trading strategies while avoiding prime brokerage fees associated with the foreign exchange market center 100 (FIG. 1).

FIG. 8 illustrates a block diagram of a digital device 800 that may list the currency futures contract, in accordance with one embodiment. The digital device 800 is any device that may implement either hardware, software, or both. Examples of the digital devices 800 include, but are not limited to, computers, servers, terminals, personal digital assistants, cell phones, laptops, computing tablets, and personal media devices. The digital device 800 may be a node on the architecture 500 including the trader 530, 540, and 550, member of exchange 560, broker 570, trader 580, or trader 590 of FIG. 5. The digital device 800 may also be a futures exchange server 510 (FIG. 5).

The exemplary digital device 800 includes a processor 810, a memory 820, a storage system 830, an input/output (I/O) interface 840, a communications (com.) network interface 850, and a display device 860 all coupled to a system bus 870. The communications network interface 850 is further coupled to an external communications link 880. The processor 810 is configured to execute software or instructions. The memory 820 is any memory device configured to hold data, either permanently or temporarily, to make the data available to any component coupled to the system bus 870. The memory 820 may be configured to hold the currency futures contract.

The storage system 830 is any storage device or group of storage devices configured to store data permanently or temporarily. The storage system 830 may be configured to store the currency futures contract.

The I/O interface 840 is any interface or device configured to provide input or output to a user of the digital device 800. For example, the I/O interface 840 may include a video interface, a remote control, a keypad, joystick, touch-screen, or buttons.

The exemplary communications network interface 850 is any communication interface configured to transfer data between any components coupled to the system bus 870 and any communications network over an external communications link 880.

The display device 860 is any device configured to visually interact with the user of the digital device 800. For example, the display device 860 may be a television screen, a monitor, a display for a cell phone, a display for a personal digital assistant, or a terminal display.

In some embodiments, a program to create, trade, process, novate, denovate and/or implement currency futures contracts may be stored on the computer readable storage medium. In other embodiments, a program that configures a network to act as an electronic trading network that trades currency futures contracts may be stored on the computer readable medium.

The above-described functions can be comprised of instructions that are stored on a computer readable storage medium. The instructions can be retrieved and executed by the processor 810. Some examples of instructions are software, program code, computer readable code, and firmware. Some examples of computer readable storage medium are storage systems 830, memory 820, memory devices, tape, disks, integrated circuits, and/or servers. Those skilled in the art are familiar with instructions, processor(s), and storage medium.

Daily Contract Expiration

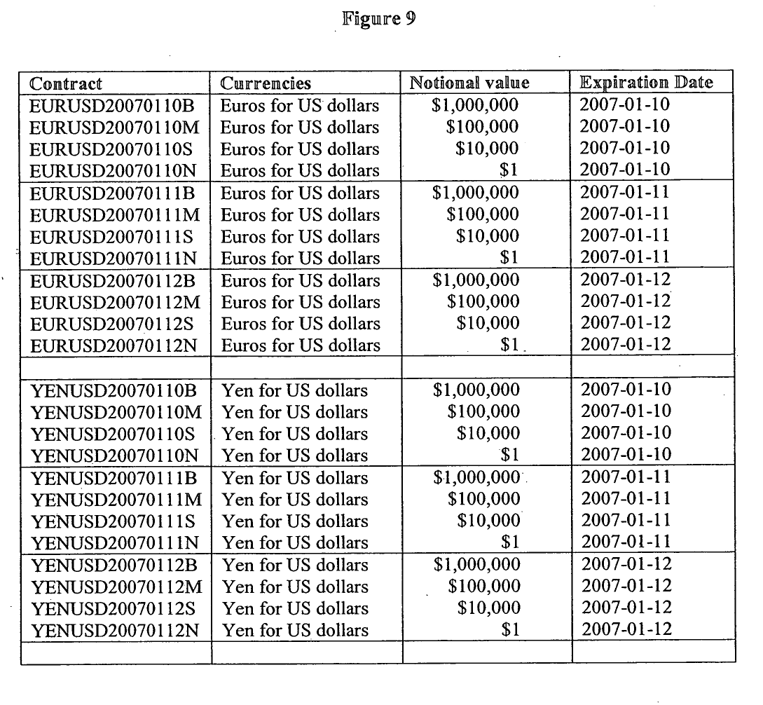

The market will also provide for establishing a series of currency futures contracts for a currency, each comprising an initial listing date, a final settlement date that is a common period of time subsequent to said initial listing date and common terms for trading said currency, said initial listing dates being more frequent than the standard contract listing dates and may be as frequent as daily. More particularly, the market will list a series of contracts designated by name and a date suffix rather than the more typical monthly suffix used in most futures contracts. In addition, one contract shall be listed for each business day in the future period to be covered by the market, and such contract will in part bear that date as part of its name. By way of non-limiting example, a contract may be called Two-Day Future, and a listing of such contract expiring on Jan. 17, 2006 would be “TDF20060117.” In addition, the market of the present invention will create a consecutive list of all contracts for business days beginning at a certain time in the future and extending to a time further in the future. In addition, the market might also will provide for establishing a series of currency futures contracts of other periodicities, for example, every other day. An example of a listing of a series of such contracts is presented as FIG. 9.

Contract with Small Monetary Amounts

The market may include contracts of smaller lots than on the existing market. For each currency contract there may be at least one monetary amount for the contract such that, by way of non-limiting example, for the Great Britain Pound contract, one contract would be in a unit of $1,000,000, and one or more contracts may be in smaller monetary amounts, including monetary amounts which could be as small as one (1) dollar or its near foreign exchange equivalent.

Having contracts for a particular currency available in several monetary amounts affords traders access to contracts for a range of different quantities of currencies, thus allowing a trader to express his economic position in a more precise manner, and further makes the futures market of the present invention available to satisfy the interests of smaller retail currency customers. The availability of contracts in several monetary amounts further creates the opportunity for arbitrage, thereby increasing liquidity in the markets.

Under one embodiment of the present invention, the respective markets in contracts for a particular currency in each of the several available monetary amounts each will be distinct and will allow for different market pricing for each such contract size. As an example, market pricing for a contract for a particular currency in the one-hundred dollar ($100) unit size will be distinct from and will not directly affect the market pricing for a contract for the same currency in the ten-thousand dollar ($10,000) unit size. Thus, as an example, if there is a great market demand for the purchase of contracts for a particular currency in the one-hundred dollar ($100) unit size, that demand may or may not affect the market pricing for a contract for the same currency in the ten-thousand dollar ($10,000) unit size. In other embodiments, only a single contract size will be listed or the trading of multiple contract sizes will be coordinated.

Novation

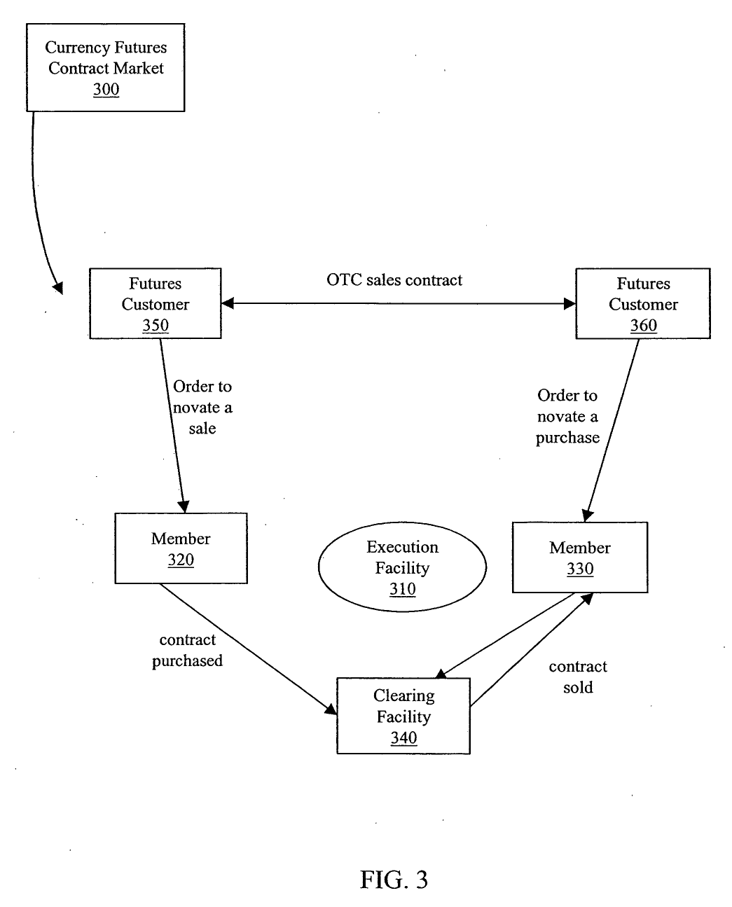

Now referring to FIG. 3, a currency futures contract market 300 is shown whereby market participant futures customers 350 and 360 can obtain clearing facility contracts without having entered into the transaction via the execution facility. One novates an over-the-counter sales contract into a clearing facility contract without needing to utilize the execution facility and without restrictions or qualifications. Customers 350 and 360 have informed their respective futures brokers/market members 320 and 330 of their over-the-counter agreement and their order to novate. The members 320 and 330, in turn, inform the clearing facility 340 which then assigns on its books and records to each of the relevant informing futures brokers 320 and 330 a clearing facility contract. The futures brokers/market members 320 and 330, in turn, hold that contract for the benefit of, and as agents for, their respective customers 350 and 360.

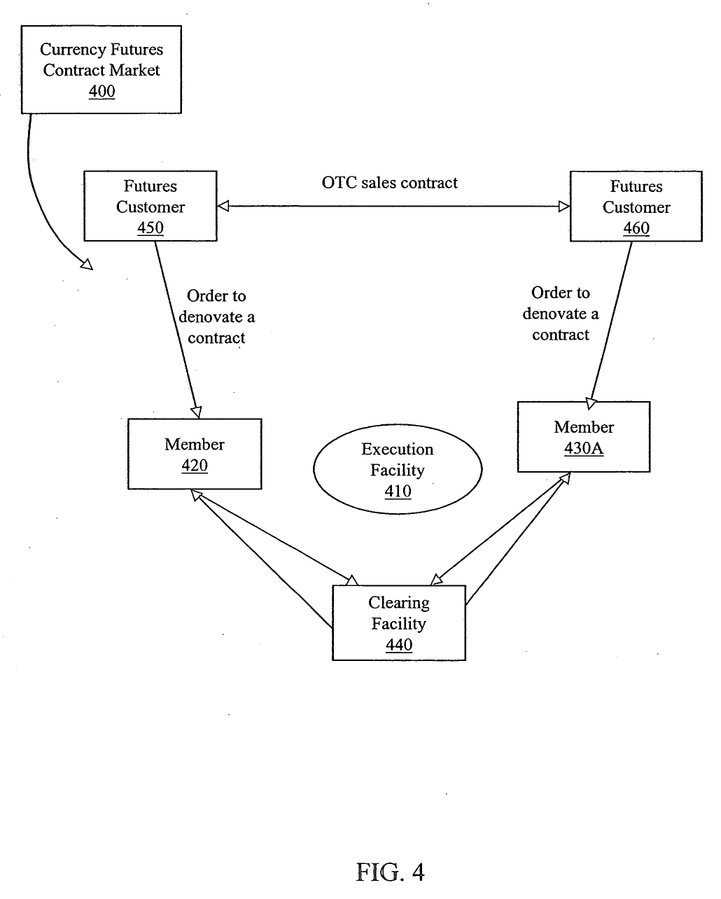

The market also will allow for the extinguishment of an existing clearing facility contract (denovation) by entering into an equal and offsetting exchange facility contract through novation. Referring to FIG. 4, denovation occurs when the futures customer parties 450 and 460 engage in a novation transaction, which in fact, offsets an existing position, as illustrated in FIG. 4.

Finally, for customers who have Contracts in accounts maintained at more than one Member, the market will allow any offsetting Contracts (that is, any purchase versus any sale of the Contract) to be offset and canceled out by the clearing facility upon the receipt of instructions from the customers that are mutually agreed upon by the Members carrying those accounts. These instructions, which could be conveyed by one or more of the Members, would indicate which accounts would hold the remaining positions. For example, if Customer A had 3 purchased Contracts in its account with Member A and 1 sales Contract in its account at Member B, then upon instructions of Customer A (accepted by Members A and B) to offset the positions and place the remainder in account with Member A, the Contracts in the two accounts would be offset having the effect of canceling 1 Contract and thereby leaving open 2 contracts to buy in the account with Member A, and canceling the Contract to sell in the account with Member B.

Enhanced Rolling

The market will also allow for periodic extensions of a participant's economic exposure by rolling forward of a contract to a nearby final settlement date which has the effect of maintaining the economic equivalence of a short-term, spot transaction.

Rolling forward of a futures contract comprises a means to move an existing position in a contract to another contract that expires on a later date. In the roll, the position in the first contract is extinguished while the position in the later contract is created. Traders can always roll their positions forward by arranging the necessary trades in the two contracts (i.e. the calendar spread) using normal trading process in each contract.

Rolling forward of the contemplated futures contract also may be achieved by one of three formal mechanisms that coordinate the trading of the two contracts: In the first alternative, by interests from subscribing long and short participants are matched to roll forward at a spread price (the difference between the later contract price and the first contract price) determined by a third party. Among others, the third party may be the exchange, the electronic trading network, the clearing house, or a consultant appointed for this purpose. The spread price would be set using the same or similar means used to set daily settlement prices. To the extent an aggregate imbalance exists, the market would allocate, either on a pro rata basis or via a lottery, the oversubscription.

In the second alternative, the exchange or electronic trading network would conduct a single price auction to which subscribers would submit bids and offers to trade the calendar spread that rolls the first contract into the later contract.

In the final alternative, traders would roll their positions forward by executing trades in continuous spread markets organized by the exchange or electronic trading network.

The short-term roll is permitted by daily listings of contracts, as described above.

The execution facility and the clearing facility will establish rules and procedures to facilitate the efficient rolling of contracts as described above. These facilities will include systems by which traders may elect to automatically subscribe to one of the various rolling mechanisms subject to limits that they may place on the spread prices that they will accept.

Enhanced Final Settlement Procedures

A final aspect of the market is rules of the clearing facility which facilitate more economically efficient alternatives to final settlement procedures.

The market will offer pre-qualified market participants the ability to finally settle their contracts using several settlement methods. One such final settlement method affords such participants the ability to match their contract position(s) with those of acceptable market counterparts and opt out of further participation in the settlement process. This method results in bilateral pairing of acceptable counterparts. The matched contracts are nullified and the parties presumably will have entered into an identically priced cash transaction settling on the settlement date for the amount of the original transaction, or some economically similar transaction. Another such final settlement method affords such participants the ability to have contract positions netted (reduced to a single side) across all accounts maintained by a single customer with two or more clearing members and then to be cash settled by the market in conjunction with another counterparty or counterparties with opposite contract positions being cash settled using the same procedure. Cash settlement will be made on the final settlement date. Another such final settlement method affords such participants the ability to deliver or take delivery of currency using their clearing member as a prime broker or a prime broker acceptable to them and their member in a cash transaction settling on the settlement date.

The market will provide for a method for effecting the private bilateral settlement of a currency futures contract comprising the steps of (i) enabling customers to communicate with the clearing facility, directly or through members, their election to be pre-qualified to engage in direct, bilateral settlements of clearing facility futures contracts along with certain identifying and credit information necessary to arrange and participate in such settlements, (ii) potentially verifying the identifying and credit information of qualified customers and maintaining securely such information, (iie) receiving, prior to the final settlement date at the clearing facility, a qualified customer's electronic or other request to be given access to the identity and contract position information of other qualified customers, and reacting thereto, (iv) potentially providing an interface for listing, available to any qualified customer holding an open position in a contract, identity information of each other qualified customer having an open position in such contract who has permitted the display of this information to facilitate bilateral settlement, (v) potentially providing an interface for such customers to query any one or any group concerning their willingness to denovate from the clearing facility certain contracts in order to engage in a final settlement other than through the clearing facility (an “alternative final settlement”), (vi) accepting paired qualified customers requesting alternative final settlement or, upon request, pairing together qualified customers for alternative final settlement, in either case denovating the relevant contracts of the paired pre-qualified customers whereby they will receive a direct bilateral contract with one another, (vii) adjusting appropriately the books and records of the clearing facility and the relevant members and thereby effect the denovation and the final private contract, (viii) providing an interface for the clearing facility to receive instructions from a qualified customer indicating that such customer seeks to identify such contract for direct bilateral settlement with an identified qualified customer, (ix) providing a means of notifying all interested parties of the contracts identified for direct bilateral settlement, and (x) effecting direct bilateral settlement of said contract.

The above settlement procedure shifts any risks and obligations associated with such direct bilateral settlement to the participant customers and away from the clearing facility.

Finally, for customers who have Contracts in accounts maintained at more than one Member, the market will allow any offsetting Contracts (that is, any purchase versus any sale of the Contract) to be offset and canceled out by the clearing facility upon the receipt of instructions from the customer or customers whose positions offset. These instructions, which could be conveyed by one or more of the Members, would indicate which accounts would hold the remaining positions. For final settlement, the Members' consent to offset will not be required.

### Exemplary Embodiment of Exchange Process

In one exemplary embodiment of the exchange process, a fresh contract, in each currency pair (for example, U.S. dollars and Japanese Yen) of the various contract monetary amounts offered, including full sized ($1,000,000); medium sized ($100,000); small sized ($10,000) and nano sized ($1), is listed for trading on the market's trade execution facility (“trading facility”) on each business day, beginning, for example, with Jan. 1, 2007, each having a final settlement date which is a fixed number of business days after its date of listing and at least one business day after the final settlement date of the immediately preceding contract. For example, a “full size” (that is, $1,000,000) seven-day-future (“FSDF”) contract listed on Jan. 1, 2007 (assuming two (2) intervening non-business days) will have a final settlement date of January 10, and will be identified by its final settlement date as FSDF20070110 (the “Contract”); further, the immediately succeeding FSDF contract listed on Jan. 2, 2007 (also assuming two (2) intervening non-business days) will have a final settlement date of Jan. 11, 2007 and will be identified as FSDF20070111 (the “Next Contract”). A similar process will occur in respect of each of the various monetary amount contracts offered.

At any time prior to the final settlement date for a contract, a customer (“Customer A”) of a member of the new market (“Member A”) who has traded, or is intending to trade, in the Contract, prequalifies to elect for special, enhanced contract settlement procedures by providing the market's central contract clearing facility (“clearing facility”), either directly or through a member, with specified identification and financial information relevant to itself, as well as identifying and financial information about the other customers with whom direct, bilateral contract settlement would be acceptable (collectively, “Pre-qualified Customers”).

On January 7, Customer A seeking an economic exposure to yen equal to $10,505,000 places an order through its broker, who is a member of the market (Member A), to buy 10 full Contracts, 5 medium Contracts and 5,000 nano Contracts, all expiring on Jan. 10, 2007, and is matched through the trading facility with one or more sellers of similar Contracts totaling the same value. For simplification purposes, this example will assume the match is with a single seller (“Customer B”), a customer of a different member of the market (“Member B”). Alternatively, Customer A and Customer B could directly negotiate a private sale of said Contracts and each inform its respective member. In either alternative, the Contracts are novated to the clearing facility such that Member A and Member B are credited by the clearing facility with having, respectively, bought and sold the Contracts. In turn, each of Member A and Member B credits its respective customer's account with the Contracts.

After the close of trading on Jan. 7, 2007 and of each trading session thereafter, the clearing facility, either alone or in conjunction with the execution facility or designated consultants, calculates a settlement price of the Contract, and for each other contract then listed, for purposes of marking to market and determination of variation margin requirements.

On January 8 the number of the Contracts credited by the clearing facility to Member A is reduced by 5 full Contracts ($5,000,000) as a result of either (a) Customer A selling, and another trader who may or may not be Customer B buying, 5 full Contracts expiring on Jan. 10, 2007 through their respective members through the trading facility or, alternatively, by a privately negotiated agreement whereby Customer A sells, and another person, who may or may not be Customer B, buys 5 full Contracts. In either alternative, this results in a novation of all such Contracts to the clearing facility as Contracts between the clearing facility and Member A and the member of its counterparty, and a netting to the extent it is offsetting with each of Member A's or the other involved counterparty's preexisting Contracts with the clearing facility.

At any time before a predetermined cutoff time on the day prior to the final settlement date Customer A or Customer B, or both, determine to extend part of their remaining exposure by rolling forward 3 Full Contracts out of the FSDF20070110 contract into a subsequent contract, for example, the FSDF20070111 contract (the “New Contract”). Customer A informs the exchange through its Member A that it wishes to participate in the single price auction arranged by the exchange to facilitate the roll. A further indicates that it will accept a spread up to and including some specified amount. The exchange arranges the spread trade and reports to Customer A through Member A that the roll has successfully been arranged and the terms of the roll.

Before COB on January 9 (one business day before the January final 10 settlement date of the Contract) at a predetermined time, Customer A and Customer B, and all other Pre-qualified Customers, are given access to identifying and Contract position information of all other Pre-qualified Customers and have until a predetermined time to report to the clearing facility any bilaterally negotiated agreements to finally settle any or all of the Contracts, which may be accomplished on terms satisfactory to the parties, including by actual delivery and pay, arranged directly or through market intermediaries, such as a member or OTC prime broker, and/or by netting and setoff against other opposite delivery and payment obligations due on January 10.

Each of the above steps will apply to the Next Contract and to each subsequently listed contract.

In some embodiments, a program to create, trade, process, novate and/or implement currency futures contracts may be stored on the computer readable storage medium. In other embodiments, a program that configures a network to act as an electronic trading network that trades currency futures contracts may be stored on the computer readable medium.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments of the present invention have been described. It will be understood that various modifications may be made without departing from the spirit and scope of the invention. Therefore, other implementations are within the scope of the following claims.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

We claim:

1. A method for operating an electronic exchange to provide a marketplace for the trading and settling of currency futures contracts comprising the steps of:
establishing at least one series of at least more than one currency futures contracts for the purchase of a particular currency and sale of another particular currency, wherein each such contract is comprised of
a monetary amount that is denominated in one of said two particular currencies, wherein said monetary amount is the same for each such contract in the series,
an initial listing date, wherein for each such contract in the series other than the first such contract in the series, said initial listing date is a common fixed number of at least one but not more than five business days following the initial listing date of the immediately prior contract in the series,
a final settlement date that is subsequent to said initial listing date, and
other terms for trading said currencies, and
providing an interface for listing information concerning each such contract.

2. The method of claim 1, wherein said monetary amount is ten thousand or less.

3. The method of claim 1, wherein said information concerning each said currency futures contract listed via said interface comprises information from among the set including an identifier for such contract, such contract's last bid price, such contract's last offered price and such contract's executed transaction price.

4. The method of claim 1, wherein said other terms for such contract include a provision whereby such contract can be indicated as elected by a purchaser or seller of such contract to be, on or prior to such contract's final settlement date, extinguished automatically and replaced with a new contract with a later final settlement date than said contract.

5. The method of claim 1, comprising the further step of receiving, for each such contract, orders to purchase a quantity of such contracts at a specified bid price and/or orders to sell a quantity of such contracts at a specified offer price.

6. The method of claim 5, comprising the further step of matching an order to purchase a quantity of a specified contract at a specified bid price with an order to sell a quantity of the same specified contract at a specified offer price.

7. The method of claim 6, comprising the further step of providing notice to each member that placed an order which has been matched that such order has been matched.

8. The method of claim 7, wherein said other terms for such contract include a provision specifying, for the new contract, the number of business days later than the final settlement date of the original matched contract, for such new contract's final settlement date.

9. The method of claim 6, comprising the further step of causing a new contract to be entered into in response to receiving instructions from at least one purchaser or seller that placed an order which has been matched, that such original matched contract be extinguished and replaced with a new contract, with a later final settlement date than the final settlement date of said original matched contract.

10. The method of claim 9, wherein said new contract shall have a final settlement date that is a specified number of business days after the final settlement date of said original matched contract.

11. The method of claim 6, wherein the final settling occurs via private bilateral final settlement comprising the further steps of
receiving instructions from at least one purchaser or seller that placed an order which has been matched indicating that such purchaser or seller has elected to engage in private bilateral final settlement of such matched contract,
receiving prior to the final settlement date said purchaser or seller's request to be given access to identity and contract position information of certain other market participants,
providing an interface for receiving instructions from said purchaser or seller indicating that such purchaser or seller desires such contract to be settled via such private bilateral final settlement with an other market participant and an identification of such other market participant,
providing an interface for displaying each such contract identified for direct bilateral final settlement, and
causing the final settlement of said contract external to the clearing facility.

12. The method of claim 11, comprising the further step of determining whether said one purchaser or seller meets qualifications to engage in private bilateral final settlement.

13. A method for operating an electronic exchange to provide a marketplace for the trading and settling of currency futures contracts comprising the steps of:
establishing at least one series of at least more than one currency futures contracts for the purchase of a particular currency and sale of another particular currency, wherein each such contract is comprised of
a monetary amount of ten thousand or less that is denominated in one of said two particular currencies, wherein said monetary amount is the same for each such contract in the series,
an initial listing date, wherein for each such contract in the series other than the first such contract in the series, said initial listing date is a common fixed number of business days following the initial listing date of the immediately prior contract in the series,
a final settlement date that is subsequent to said initial listing date, and
other terms for trading said currencies, and
providing an interface for listing information concerning each such contract.

14. The method of claim 13, wherein said initial listing date is a common fixed number of at least one but not more than five business days following the initial listing date of the immediately prior contract in the series.

15. The method of claim 13, wherein said information concerning each said currency futures contract listed via said interface comprises information from among the set including an identifier for such contract, such contract's last bid price, such contract's last offered price and such contract's executed transaction price.

16. The method of claim 13, wherein said other terms for such contract include a provision whereby such contract can be indicated as elected by a purchaser or seller of such contract to be, on or prior to such contract's final settlement date, extinguished automatically and replaced with a new contract with a later final settlement date than said contract.

17. The method of claim 13, comprising the further step of receiving, for each such contract, orders to purchase a quantity of such contracts at a specified bid price and/or orders to sell a quantity of such contracts at a specified offer price.

18. The method of claim 17, comprising the further step of matching an order to purchase a quantity of a specified contract at a specified bid price with an order to sell a quantity of the same specified contract at a specified offer price.

19. The method of claim 18, comprising the further step of providing notice to each member that placed an order which has been matched that such order has been matched.

20. The method of claim 19, wherein said other terms for such contract include a provision specifying, for the new contract, the number of business days later than the final settlement date of the original matched contract, for such new contract's final settlement date.

21. The method of claim 19, comprising the further step of causing a new contract to be entered into in response to receiving instructions from at least one purchaser or seller that placed an order which has been matched, that such original matched contract be extinguished and replaced with a new contract, with a later final settlement date than the final settlement date of said original matched contract.

22. The method of claim 21, wherein said new contract shall have a final settlement date that is a specified number of business days after the final settlement date of said original matched contract.

23. The method of claim 19, wherein the settling occurs via private bilateral final settlement comprising the further steps of
receiving instructions from at least one purchaser or seller that placed an order which has been matched indicating that such purchaser or seller has elected to engage in private bilateral final settlement of such matched contract,
receiving prior to the final settlement date said purchaser or seller's request to be given access to identity and contract position information of certain other market participants,
providing an interface for receiving instructions from said purchaser or seller indicating that such purchaser or seller desires such contract to be settled via such private bilateral final settlement with an other market participant and an identification of such other market participant,
providing an interface for displaying each such contract identified for direct bilateral final settlement, and
causing the final settlement of said contract external to the clearing facility.

24. The method of claim 23, comprising the further step of determining whether said one purchaser or seller meets qualifications to engage in private bilateral final settlement.

25. A system for operating an electronic exchange to provide a marketplace for the trading and settling of currency futures contracts comprising:
a database having at least one series of at least more than one currency futures contracts for the purchase of a particular currency and sale of another particular currency, wherein each such contract is comprised of
a monetary amount that is denominated in one of said two particular currencies, wherein said monetary amount is the same for each such contract in the series,
an initial listing date, wherein for each such contract in the series other than the first such contract in the series, said initial listing date is a common fixed number of at least one but not more than five business days following the initial listing date of the immediately prior contract in the series,
a final settlement date that is subsequent to said initial listing date, and
other terms for trading said currencies, and
an interface for listing information concerning each such contract.

26. The system of claim 25, wherein said monetary amount is ten thousand or less.

27. The system of claim 25, wherein said information concerning each said currency futures contract listed via said interface comprises information from among the set including an identifier for such contract, such contract's last bid price, such contract's last offered price and such contract's executed transaction price.

28. The system of claim 25, wherein said other terms for such contract include a provision whereby such contract can be indicated as elected by a purchaser or seller of such contract to be, on or prior to such contract's final settlement date, extinguished automatically and replaced with a new contract with a later final settlement date than said contract.

29. The system of claim 25, further comprising input means for receiving for each such contract purchaser or seller orders to purchase a quantity of such contracts at a specified bid price and/or orders to sell a quantity of such contracts at a specified offer price.

30. The system of claim 29, further comprising means for matching an order to purchase a quantity of a specified contract at a specified bid price with an order to sell a quantity of the same specified contract at a specified offer price.

31. The system of claim 30, further comprising notification means for notifying each purchaser or seller that placed an order which has been matched that such order has been matched.

32. The system of claim 31, wherein said other terms for such contract include a provision specifying, for the new contract, the number of business days later than the final settlement date of the original matched contract, for such new contract's final settlement date.

33. The system of claim 30, further comprising means for causing a new contract to be entered into in response to receiving instructions from at least one purchaser or seller that placed an order which has been matched, that such original matched contract be extinguished and replaced with a new contract, with a later final settlement date than the final settlement date of said original matched contract.

34. The system of claim 33, wherein said new contract shall have a final settlement date that is a specified number of business days after the final settlement date of said original matched contract.

35. The system of claim 30, further comprising means for effecting private bilateral final settlement of a matched contract comprising the steps of
receiving instructions from at least one purchaser or seller that placed an order which has been matched indicating that such purchaser or seller has elected to engage in private bilateral final settlement of such matched contract,
receiving prior to the final settlement date said purchaser or seller's request to be given access to identity and contract position information of certain other market participants,
providing an interface for receiving instructions from said purchaser or seller indicating that such purchaser or seller desires such contract to be settled via such private bilateral final settlement with an other market participant and an identification of such other market participant,
providing an interface for displaying each such contract identified for direct bilateral final settlement, and
causing the final settlement of said contract external to the clearing facility.

36. The system of claim 35, further comprising determining whether said one purchaser or seller meets qualifications to engage in private bilateral final settlement.

37. The system of claim 25, further comprising a clearing facility for novating a matched contract such that said clearing facility becomes party to a new contract with the purchaser and seller.
